(19) United States
(12) Patent Application Publication
(10) Pub. No.: US 2013/0015797 A1
(43) Pub. Date: Jan. 17, 2013

(54) ELECTRONIC CONTROL UNIT FOR VEHICLE AND SEMICONDUCTOR INTEGRATED CIRCUIT DEVICE

(71) Applicant: Akito ITOU, Kariya-city (JP)

(72) Inventor: Akito ITOU, Kariya-city (JP)

(73) Assignee: DENSO CORPORATION, Kariya-city (JP)

(21) Appl. No.: 13/534,288

(22) Filed: Jun. 27, 2012

(30) Foreign Application Priority Data
Jul. 11, 2011 (JP) 2011-152798

(51) Int. Cl. H02P 6/12

(52) U.S. Cl. 318/400.21

(57) ABSTRACT

A semiconductor integrated circuit device for an electronic control unit includes a drive circuit, a prohibition circuit and a pulse monitor circuit. The drive circuit drives an in-vehicle load according to a driving signal outputted from a microcomputer. The pulse monitor circuit monitors a pulse signal outputted from the microcomputer when the microcomputer is in a normal state. The pulse monitor circuit resets the microcomputer and instructs the prohibition circuit to prohibit the drive circuit from driving the in-vehicle load when it is determined that the microcomputer is in an abnormal state. Further, the pulse monitor circuit instructs the prohibition circuit to permit the drive circuit to drive the in-vehicle load when it is determined that the microcomputer is in the normal state after resetting of the microcomputer.

### CROSS REFERENCE TO RELATED APPLICATION

This application is based on Japanese Patent Application No. 2011-152798 filed on Jul. 11, 2011, the disclosure of which is incorporated herein by reference.

### TECHNICAL FIELD

The present disclosure relates to an electronic control unit having a microcomputer for controlling an in-vehicle load, and a semiconductor integrated circuit device.

### BACKGROUND For example, JP2003-214233A, which corresponds to U.S.2003/0144778A1, describes an in-vehicle electronic control unit having a control microcomputer for controlling an engine as an in-vehicle load and a monitor microcomputer for monitoring the control microcomputer. When the monitor microcomputer determines that a malfunction has occurred in the control microcomputer, the monitor microcomputer resets the control microcomputer to temporarily stop operation of the control microcomputer.

When being returned from the resetting, the control microcomputer begins a drive control of the in-vehicle load. In this case, if there is a malfunction in processing of the control microcomputer after the resetting, the monitor microcomputer determines that the malfunction has occurred in the control microcomputer and resets the control microcomputer again. However, in a period from the returning of the control microcomputer from the resetting to the redetection of the malfunction of the control microcomputer by the monitor microcomputer, there is a possibility that the control microcomputer performs an abnormal processing to the in-vehicle load.

### SUMMARY

According to an aspect of the present disclosure, a semiconductor integrated circuit device is integrally provided with a drive circuit, a prohibition circuit and a pulse monitor circuit. The drive circuit drives an in-vehicle load according to a driving signal outputted from a microcomputer. The pulse monitor circuit monitors a pulse signal outputted from the microcomputer. When the pulse signal is in an abnormal state, the pulse monitor circuit resets the microcomputer and instructs to the inhibition circuit to inhibit the drive circuit from driving the in-vehicle load. The pulse monitor circuit instructs the inhibition circuit to remove the prohibition of the driving of the in-vehicle load against the drive circuit when it is determined that the microcomputer is in a normal state after the resetting.

In such a configuration, since the drive circuit is permitted to drive the in-vehicle load when it is determined that the microcomputer is in the normal state after the resetting. Therefore, it is less likely that the in-vehicle load will be undesirably operated by the microcomputer even if the microcomputer is in an abnormal state after the resetting.

### BRIEF DESCRIPTION OF THE DRAWINGS

The above and other objects, features and advantages of the present disclosure will become more apparent from the following detailed description made with reference to the accompanying drawings, in which like parts are designated by like reference numbers and in which:

FIG. 1 is a diagram illustrating an electric structure of an electronic control unit according to an embodiment of the present disclosure;

FIG. 2 is a diagram illustrating an electric structure of a prohibition circuit and an in-vehicle load drive circuit of the electronic control unit according to the embodiment;

FIG. 3 is a diagram illustrating an electric structure of a motor drive circuit of the electronic control unit according to the embodiment; and

FIGS. 4A and 4B are diagrams illustrating signal waveforms and a state of a microcomputer of the electronic control unit according to the embodiment.

### DETAILED DESCRIPTION

An exemplary embodiment of the present disclosure will be described hereinafter with reference to the drawings.

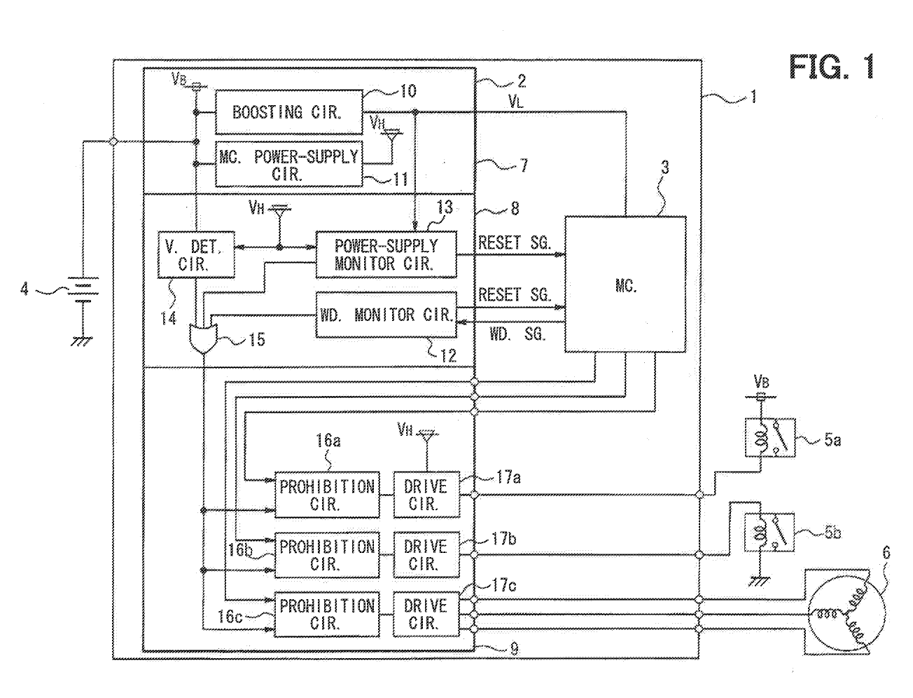

As shown in FIG. 1, an electronic control unit (ECU) 1 generally includes a control IC 2 as a semiconductor integrated circuit device and a microcomputer 3 for drive controlling in-vehicle loads such as relays 5a, 5b and a motor 6. The ECU 1 is supplied with electric power from an in-vehicle battery 4.

The control IC 2 includes a power supply circuit section 7, a monitor circuit section 8 and a drive circuit section 9. The power supply circuit section 7 includes a microcomputer power supply circuit 10 and a boosting circuit 11. When the in-vehicle battery 4 supplies the microcomputer power supply circuit 10 with a power-supply voltage VB (e.g., 12V), the microcomputer power supply circuit 10 generates a constant voltage VL (e.g., 5V) to supply an electric current to the microcomputer 3. The boosting circuit 11 boosts the power-supply voltage VB using a charging pump circuit or the like to generate a high voltage VH (e.g., 30V).

The monitor circuit section 8 includes a watchdog monitor circuit 12, a power supply monitor circuit 13 and a voltage detection circuit 14. The watchdog monitor circuit 12 is provided as a pulse monitor circuit. The watchdog monitor circuit 12 receives a watchdog signal as a pulse signal at predetermined time intervals from the microcomputer 3. The watchdog monitor circuit 12 generates a reset signal to reset the microcomputer 3 when the output of the watchdog signal is interrupted due to the microcomputer 3 being in an abnormal state. Also, the watchdog monitor circuit 12 begins to output a prohibition signal for prohibiting the driving of the in-vehicle loads at the same time as resetting the microcomputer 3. The watchdog monitor circuit 12 stops the output of the prohibition signal when a predetermined number of watchdog signals has been received after the microcomputer 3 returned from a reset state.

The power supply monitor circuit 13 monitors the constant voltage VL outputted from the microcomputer power supply circuit 10. When the constant voltage VL is equal to or lower than a predetermined level, the power supply monitor circuit 13 outputs a reset signal to the microcomputer 3 as well as outputs a prohibition signal. The power supply monitor circuit 13 stops the output of the reset signal when the constant voltage VL outputted from the microcomputer power supply circuit 10 exceeds the predetermined level. The power supply monitor circuit 13 is supplied with the high voltage VH generated from the boosting circuit 11, so that the power supply monitor circuit 13 can perform the detection of the constant voltage VL even when the power-supply voltage is decreased.

The voltage detection circuit 14 monitors the power-supply voltage VB of the power supply circuit section 7. When the power-supply voltage VB is equal to or lower than a predetermined level, the voltage detection circuit 14 outputs a prohibition signal.

The prohibition signals outputted from the watchdog monitor circuit 12, the power supply monitor circuit 13 and the voltage detection circuit 14 are provided to the drive circuit section 9 through a NOR circuit 15.

The drive circuit section 9 includes prohibition circuits 16a, 16b, 16c and drive circuits 17a, 17b, 17c, corresponding to the relays 5a, 5b and the motor 6 as the in-vehicle loads. Each of the prohibition circuits 16a, 16b, 16c receives a driving signal from the microcomputer 3 and the prohibition signal from the monitor circuit section 8. In a state where the prohibition signal is inputted to the prohibition circuit 16a, 16b, 16c, the prohibition circuit 16a, 16b, 16c invalidates the driving signal from the microcomputer 3, even if the driving signal indicates a drive state, so as to prohibit driving of the corresponding in-vehicle load, such as the relay 5a, 5b or the motor 6.

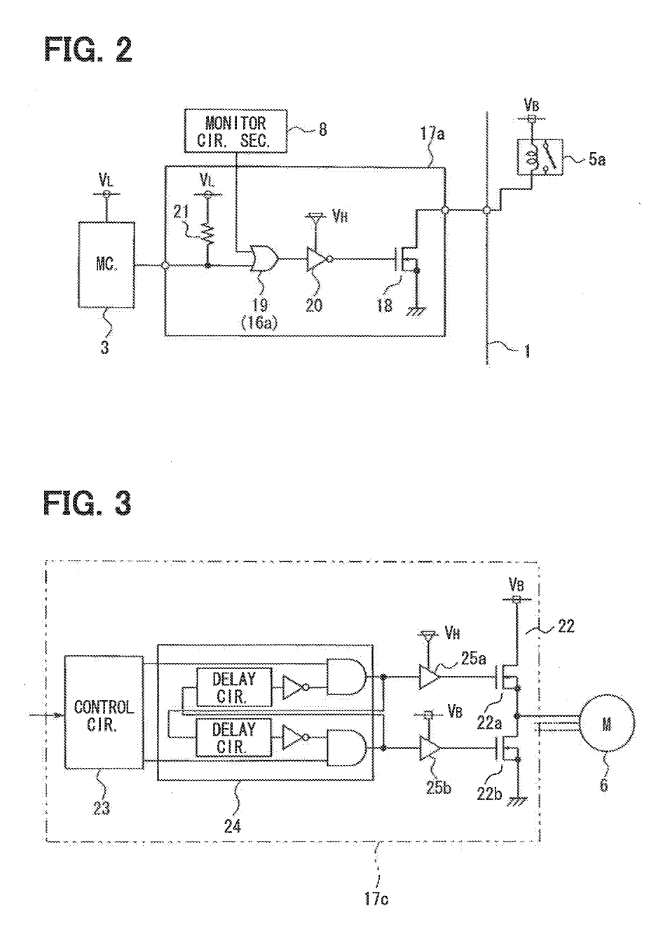

FIG. 2 is a diagram illustrating an electric structure of the drive circuit 17a and the prohibition circuit 16a in detail. The relay 5a is disposed to be supplied with the power-supply voltage VB. The relay 5a is driven, that is, turned on and off by an N-channel MOSFET 18 arranged in a low-side manner.

The driving signal outputted from the microcomputer 3 is provided to the gate of the MOSFET 18 through an OR circuit 19, which is provided as the prohibition circuit 16a, and a NOT circuit 20. The driving signal being at a low level corresponds to an on signal. The driving signal being in a high impedance state corresponds to an off signal. A pull-up resistor 21 as a logic fixed resistance is connected to an input terminal of the OR circuit 19 to pull up an electric potential to the power-supply voltage VB in the high-impedance state.

The other input terminal of the OR circuit 19 receives the prohibition signal from the monitor circuit section 8. The NOT circuit 20 is supplied with the high voltage VH of the boosting circuit 11 as a power source of the NOT circuit 20. The NOT circuit 20 applies the gate of the MOSFET 18 with the high voltage VH to drive the gate of the MOSFET 18. Since the gate of the N-channel MOSFET 18 is driven by the high voltage VH, the MOSFET 18 is turned on with a lower on resistance.

FIG. 3 is a diagram illustrating an electric structure of the drive circuit 17c for driving the motor 6 as the in-vehicle load in detail. The motor 6 is a three-phase motor and is driven by a three-phase inverter circuit 22. The inverter circuit 22 has three arms. Each of the arms includes two N-channel MOSFETs as driving transistors connected in series between a terminal of the battery 4 (power-supply voltage VB) and a ground. In FIG. 3, only one arm including N-channel MOSFETs 22a, 22b is illustrated as an example.

Each of the MOSFETs 22a, 22b is driven in accordance with a PWM signal that is generated from a control circuit 23 based on the driving signal outputted from the microcomputer 3. The PWM signals for the two MOSFETs 22a, 22b are inputted into a short-circuit restricting circuit 24, and adjusted in the short-circuit restricting circuit 24 so as to prevent the two MOSFETs 22a, 22b from being turned on at the same time. Then, the adjusted PWM signals are transmitted to the gates of the MOSFETs 22a, 22b through buffer circuits 25a, 25.

The buffer circuit 25a is supplied with the high voltage VH, which is generated by the boosting circuit 11, to drive the MOSFET 22a on a high side at a voltage higher than the power-supply voltage VB. The buffer circuit 25b is supplied with the power-supply voltage VB to drive the MOSFET 22b on a low side.

The short-circuit restricting circuit 24 provides a flip flop circuit including delay circuits. In a state where a driving signal at a high level is applied to one of the buffer circuit 25a and the buffer circuit 25b and a stop signal at a low level is applied to the other of the buffer circuit 25a and the buffer circuit 25b, when the state is changed to a state of applying the stop signal at low level to the one, this output is transmitted to the other through the delay circuit at a delayed timing. Therefore, the driving signal at the high level of the other is validated at the delayed timing.

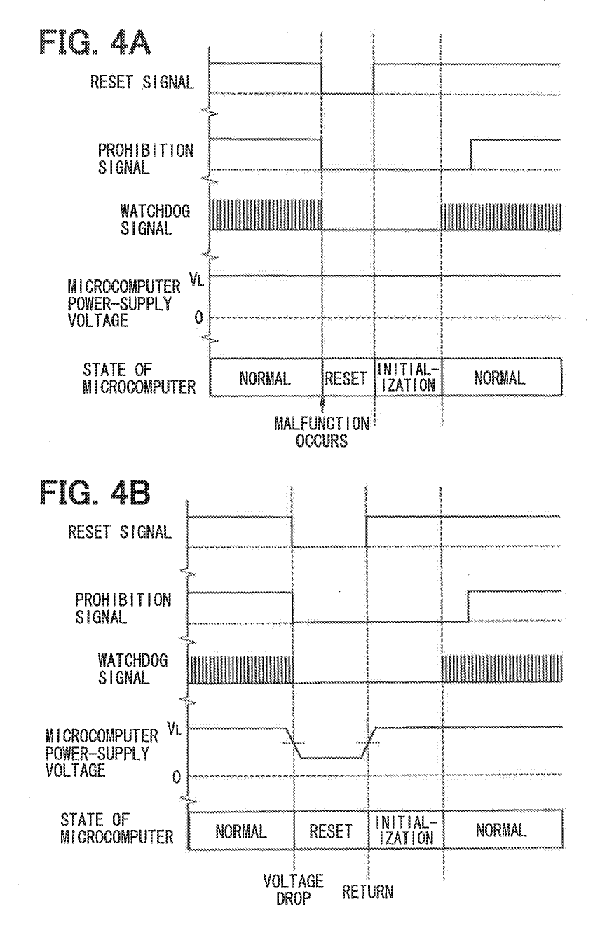

Next, operations of the ECU 1 will be described with reference to FIGS. 4A and 4B. First, a reset operation relating to an operation state of the microcomputer 3 will be described with reference to FIG. 4A.

When the ECU 1 is supplied with the electric power, the microcomputer power supply circuit 10 of the power supply circuit section 7 generates the constant voltage VL and applies the constant voltage VL to the microcomputer 3 as an activation power source for activating the microcomputer 3. When being activated, the microcomputer 3 begins a predetermined operation and begins to output the watchdog signal. The watchdog monitor circuit 12 does not output the reset signal to the microcomputer 3 while the watchdog signal is outputted from the watchdog monitor circuit 12 at predetermined timings.

In the above state, when the driving signals for driving the relays 5a, 5b and the motor 6 as the in-vehicle loads are outputted from the microcomputer 3, the relays 5a, 5b and the motor 6 are drive controlled through the prohibition circuits 16a, 16b, 16c and the drive circuits 17a, 17b, 17c of the drive circuit section 9. In this case, if the prohibition signal is not outputted from the monitor circuit section 8, the driving signals from the microcomputer 3 to the relays 5a, 5b and the motor 6 are permitted. Therefore, driving outputs of the drive circuits 17a, 17b, 17c are applied to the relays 5a, 5b and the motor 6.

When the output of the watchdog signal from the microcomputer 3 is stopped due to the microcomputer 3 being in an abnormal state, the watchdog monitor circuit 12 outputs the reset signal to the microcomputer 3 as well as outputs the prohibition signal to the drive circuit section 9. The microcomputer 3 is set to a reset state according to the reset signal outputted from the watchdog monitor circuit 12. When the reset signal is stopped after a certain period of time has elapsed since the microcomputer 3 was set to the reset state, the microcomputer 3 is activated and begins an initialization processing.

After the completion of the initialization processing, if the microcomputer 3 is in a normal state, that is, operates properly, the microcomputer 3 begins the predetermined operation and begins to output the watchdog signal. In this case, the watchdog monitor circuit 12 counts the number of watchdog signals outputted from the microcomputer 3. When a predetermined number of watchdog signals, such as ten watchdog signals, has been outputted, the watchdog monitor circuit 12 determines that the microcomputer 3 is in the normal state. As such, the watchdog monitor circuit 12 stops the output of the prohibition signal.

During a period where the prohibition signal is outputted, the prohibition circuits 16a, 16b, 16c prohibit the driving outputs from the drive circuits 17a, 17b, 17c to the relays 5a, 5b and the motor 6. When the prohibition signal is stopped, the driving of the relays 5a, 5b and the motor 6 by the microcomputer 3 are permitted.

If the microcomputer 3 is not properly activated after he completion of the initialization processing from the above resetting, there is a possibility that an abnormal driving signal is applied to the relays 5a, 5b or the motor 6. Even in such a case, since the prohibition signal is still outputted from the monitor circuit section 8, a prohibiting state where the prohibition circuits 16a, 16b, 16c prohibit the drive circuits 17a, 17b, 17c from driving the relays 5a, 5b and the motor 6 is continued.

Also, if the input of the watchdog signal to the watchdog monitor circuit 12 does not begin within a predetermined period after the reset signal is stopped, the watchdog monitor circuit 12 outputs the reset signal again to the microcomputer 3 to reset the microcomputer 3. In this case, the watchdog monitor circuit 12 continues the output of the prohibition signal to the drive circuit section 9.

The output of the prohibition signal is stopped after the microcomputer 3 properly returns from the reset state and begins the output of the watchdog signal. Therefore, it is less likely that the relays 5a, 5b and the motor 6 will be erroneously operated.

Next, an operation associated with a case where the power-supply voltage to the microcomputer 3 is decreased will be described with reference to FIG. 4B. The microcomputer power supply circuit 10 generates the constant voltage VL as the power source to be supplied to the microcomputer 3 (i.e., microcomputer power-supply voltage).

The power supply monitor circuit 13 monitors the microcomputer power-supply voltage. The power supply monitor circuit 13 is supplied with the high voltage VH generated in the boosting circuit 11, so that the power supply monitor circuit 13 can continue its operation even if the voltage of the in-vehicle battery 4 as an operation power source is decreased.

In a state where the electric power is properly supplied to the microcomputer 3, the power supply monitor circuit 13 determines that the microcomputer power-supply voltage is in a normal state and maintains the power supply to the microcomputer 3 so that the driving of the relays 5a, 5b and the motor 6 is permitted.

When the microcomputer power-supply voltage generated from the microcomputer power supply circuit 10 is lower than the predetermined level, the power supply monitor circuit 13 detects the decrease in the microcomputer power-supply voltage and outputs the reset signal to the microcomputer 3. Also, the power supply monitor circuit 13 outputs the prohibition signal to the prohibition circuits 16a, 16b, 16c.

If the microcomputer power-supply voltage supplied from the microcomputer power supply circuit 10 to the microcomputer 3 is decreased lower than the predetermined level, the operation of the microcomputer 3 is affected and thereafter the output of the watchdog signal is stopped. In this case, the power supply monitor circuit 13 resets the microcomputer 3 based on the decrease in the microcomputer power-supply voltage before an abnormal operation of the microcomputer 3 occurs.

The microcomputer 3 is held in the reset state during the period where the microcomputer 3 receives the reset signal. When the microcomputer 3 is set to the reset state, the relays 5a, 5b and the motor 6 are immediately set to a prohibited state where the driving thereof is prohibited. In this state, the watchdog monitor circuit 12 also outputs the prohibition signal according to the reset state of the microcomputer 3.

Thereafter, when the microcomputer 3 returns from the reset state as the microcomputer power-supply voltage exceeds the predetermined level, the power supply monitor circuit 13 stops the output of the reset signal and the output of the prohibition signal. On the other hand, the watchdog monitor circuit 12 continues the output of the prohibition signal.

When the output of the reset signal is stopped, that is, the microcomputer 3 is released from the reset state, the microcomputer 3 is initialized. When the microcomputer 3 is properly activated, the microcomputer 3 performs the predetermined process and begins to output the watchdog signals.

The watchdog monitor circuit 12 counts the watchdog signals outputted from the microcomputer 3. When the number of the watchdog signals reaches the predetermined number, the watchdog monitor circuit 12 stops the output of the prohibition signal to permit the driving of the relays 5a, 5b and the motor 6 by the microcomputer 3.

Accordingly, in a case where the microcomputer 3 does not operate properly after the completion of the initialization processing, the output of the prohibition signal is continued since the watchdog signals are not properly outputted. Therefore, it is less likely that the relays 5a, 5b and the motor 6 will be erroneously operated.

Next, an operation of the voltage detection circuit 14, which detects the power-supply voltage VB for driving the relays 5a, 5b and the motor 6, will be described. The voltage detection circuit 14 monitors the power-supply voltage VB supplied from the in-vehicle battery 14. When the power-supply voltage VB is lower than the predetermined, voltage, the voltage detection circuit 14 detects the decrease in the power-supply voltage VB and outputs the prohibition signal.

When the prohibition signal is outputted from the voltage detection circuit 14, the in-vehicle loads are immediately set to the prohibited states to restrict an unstable operation or an abnormal operation of the in-vehicle loads due to the decrease in the power-supply voltage VB.

After the power-supply voltage VB returns to a normal level higher than the predetermined level, if the microcomputer 3 is in the normal state, the control operation of the relays 5a, 5b and the motor 6 are started. On the other hand, if the microcomputer power-supply voltage VL is also lower than the predetermined level, the control operation of the relays 5a, 5b and the motor 6 is performed after the microcomputer 3 is released from the reset state and begins to operate properly and the predetermined number of the watchdog signals are counted.

Next, an operation of the drive circuit 17a for driving the relay 5a will be described in detail with reference to FIG. 2. The relay 5a is connected to be supplied with electric power of the power-supply voltage VB. The electric power supply to the relay 5a is controlled by the MOSFET 18. Hereinafter, the driving operation of the drive circuit 17a will be described with regard to the case where the driving signal at the low level is outputted from the microcomputer 3 to drive the relay 5a.

The driving signal to drive the relay 5a is at the low level when the prohibition signal is not outputted from the monitor circuit section 8. Therefore, the OR circuit 19 outputs the low level signal, and the inverter circuit 20 inverts the low level signal into a high level signal.

Because the inverter circuit 20 is supplied with the high voltage VH generated in the boosting circuit 11 as a power source, a voltage approximate to the high voltage VH is applied to the gate of the MOSFET 18. With this, the MOSFET 18 is turned to the on state, and the electric current is supplied to the relay 5a.

In this case, since the gate of the MOSFET 18 is biased by the high voltage VH, the on resistance is reduced and heat loss is reduced, as compared with a case where the gate of the MOSFET 18 is biased by the voltage at a level of the power-supply voltage VB.

In a case where the prohibition signal at the high level is outputted from the monitor circuit section 8, the output signal of the OR circuit 19 changes to the high level irrespective of the driving signal from the microcomputer 3. Thus, the inverter circuit 20 outputs the low level at the low level to turn off the MOSFET 18. As such, the electric current to the relay 5a is immediately shut off.

In a case where the output of the driving signal from the microcomputer 3 is stopped or in a case where the microcomputer 3 is in the reset state, the output terminal of the microcomputer 3 for outputting the driving signal becomes in the high impedance state. In this case, the input of the OR circuit 19 is fixed to the high level state of the constant voltage VL by the pull-up resistance 21. Also in this case, the MOSFET 18 is turned off, and the electric current to the relay 5a is shut off.

Next, an operation of the drive circuit 17c for driving the motor 6 will be described with reference to FIG. 3. In a state where the prohibition signal is not outputted, the driving signal outputted from the microcomputer 3 is applied to the drive circuit 17c through the prohibition circuit 16c. In the drive circuit 17c, the control circuit 23 generates the PWM signals for driving the motor 6. The PWM signals are provided to the gates of the MOSFETs 22a, 22b through the short-circuit restricting circuit 24 and the buffer circuits 25a, 25b. In the short-circuit restricting circuit 24, the PWM signals are adjusted so that the on time of the PWM signals do not coincide with each other to prevent the voltages from being applied to the gates of the MOSFETs 22a, 22b at the same time.

In the short-circuit restricting circuit 24, a signal outputted to one of the high-side and the low-side is at the high level and a signal outputted to the other of the high-side and the low-side is at the low level. In this condition, when the levels of the PWM signals inputted to the circuit 24 are switched, the signal outputted to the other is maintained at the low level even if the PWM inputted to the other is switched from the low level to the high level and an AND input is switched. On the other hand, the signal outputted to the one is switched from the high level to the low level as the PWM signal inputted to the one is switched from the high level to the low level and the AND input is switched to the low level. With this, the AND input of the other is switched to the high level after a predetermined time delayed through the delay circuit, and the signal outputted to the other is switched to the high level.

When the output of the AND circuit is switched to the high level, the buffer circuit 25a applies the high voltage VH of the boosting circuit 11 to the gate of the MOSFET 22a to turn on the MOSFET 22a, and the buffer circuit 25b applies the power source voltage VB to the gate of the MOSFET 22 to turn on the MOSFET 22b.

Therefore, when the MOSFET 22a is in the on state, the MOSFET 22b is turned on after the MOSFET 22a is securely changed to the off state as the driving signal applied to the, gate of the MOSFET 22a is switched to the off signal Likewise, when the MOSFET 22b is in the on state, the MOSFET 22a is turned on after the MOSFET 22b is securely changed to the off state. The motor 6 is supplied with three-phase currents from the inverter circuit 22, and is controlled so that a rotor of the motor 6 is rotated in a predetermined state.

When the prohibition signal is outputted from the monitor circuit section 8, the prohibition circuit 16c prohibits the driving operation of the drive circuit 17c, thereby to stop the rotation of the motor 6. When the prohibition signal is stopped, the drive circuit 17c performs the driving operation to drive the motor 6 again according to the driving signal from the microcomputer 3.

According to the present embodiment described above, the following advantageous effects are achieved.

The control IC 2 is provided with the watchdog monitor circuit 12. The watchdog monitor circuit 12 monitors the operation state of the microcomputer 3 based on the watchdog signal outputted from the microcomputer 3. In addition, the watchdog monitor circuit 12 outputs the prohibition signal to the prohibition circuits 16a, 16b, 16c when detecting an abnormal state of the microcomputer 3. The watchdog monitor circuit 12 stops the output of the prohibition signal when it is determined that the watchdog signal is outputted from the microcomputer 3 after the microcomputer 3 is returned to the normal state from the reset state. In such a configuration, the in-vehicle load can be held in the stopped state until it is determined that the microcomputer 3 is in the normal state. Therefore, even if an abnormal driving signal is outputted from the microcomputer 3 after the microcomputer 3 has been released from the reset state, it is less likely that the relays 5a, 5b and the motor 6 as in-vehicle loads will be driven according to the abnormal driving signal. Therefore, reliability of the ECU 1 improves.

The watchdog monitor circuit 12 determines that the microcomputer 3 is activated properly by the initialization after the resetting based on the number of watchdog signals (e.g., ten) outputted from the microcomputer 3. The watchdog monitor circuit 12 removes the prohibition signal when it is determined that the microcomputer 3 is activated normally after the resetting. Therefore, the drive control of the relays 5a, 5b and the motor 6 can be restarted after determining the normal state of the microcomputer 3 properly.

The control IC 2 is provided with the power supply monitor circuit 13. The power supply monitor circuit 13 monitors the constant voltage VL outputted from the microcomputer power supply circuit 10 to the microcomputer 3. When the power supply monitor circuit 13 detects that the constant voltage VL is equal to or lower than the predetermined level, the power supply monitor circuit 13 resets the microcomputer 3 as well as outputs the prohibition signal to stop the driving of the relays 5a, 5b and the motor 6. In such a configuration, the microcomputer 3 is reset and the driving of the relays 5a, 5b and the motor 6 is prohibited before the microcomputer 3 is brought into an inoperative state due to the decrease in the applied voltage VL. Accordingly, it is less likely that the relays 5a, 5b and the motor 6 will be erroneously operated.

The power supply circuit section 7 of the control IC 2 is provided with the boosting circuit 11 to supply electric power to the power supply monitor circuit 13. Therefore, even if the voltage is decreased due to the power supply to the control IC 2, a reference voltage necessary for the detection of the decrease in the constant voltage VL can be ensured by the high voltage VH generated by the boosting circuit 11. Accordingly, the power supply monitor circuit 13 can properly detect the decrease in the constant voltage VL.

The monitor circuit section 8 of the control IC 2 is provided with the voltage detection circuit 14. When the voltage detection circuit 14 detects the decrease in the power-supply voltage for driving the relays 5a, 5b and the motor 6, the voltage detection circuit 14 outputs the prohibition signal to the prohibition circuits 16a, 16b, 16c. Therefore, even when the power-supply voltage to the relays 5a, 5b and the motor 6 is decreased, it is less likely that an abnormal driving state will occur. Further, this operation is performed within the control IC 2. Therefore, the driving of the relays 5a, 5b and the motor 6 can be stopped immediately after the decrease in the power-supply voltage is detected.

The high voltage VH outputted from the boosting circuit 11 is used as the power source of the voltage detection circuit 14. Therefore, even if the voltage of the in-vehicle battery 4 is decreased, the operation of the voltage detection circuit 14 is not affected.

The drive circuit 17a employs the N-channel MOSFET 18 for supplying the electric current to the relay 5a as the in-vehicle load. The high voltage VH of the boosting circuit 11 is applied to the gate of the N-channel MOSFET 18 to drive the N-channel MOSFET 18. Since the gate of the N-channel MOSFET 18 is driven by the high voltage VH, the N-channel MOSFET 18 can be used in a state where the on resistance is reduced. Accordingly the power loss can be reduced, and the relay 5a is efficiently driven. In addition, the gate of the N-channel MOSFET 18 is driven by the high voltage VH that is generated by the boosting circuit 11 to supply the electric power to the voltage detection circuit 14. Namely, the boosting circuit 11 is commonly used for the voltage detection circuit 14 and the drive circuit 17a. Therefore, costs will not increase.

The drive circuit 17a has the pull-up resistor 21 at the input side thereof to constitute the logic where the driving signal outputted from the microcomputer 3 causes to stop the relay 5a during the reset state of the microcomputer 3. Therefore, even if the signal outputted from the microcomputer 3 becomes in the high impedance state during the reset state of the microcomputer 3, the relay 5a can be securely set to the off state by the control IC 2.

The control IC 2 is provided with the microcomputer power supply circuit 10 for supplying the electric power to the microcomputer 3. Therefore, the power supply monitor circuit 13 can monitor the voltage outputted from the microcomputer power supply circuit 10 within the control IC 2. Differently from a case of monitoring an external power source voltage, the number of pins of the control IC 2 can be reduced, resulting in the decrease in costs. Also, it is not necessary to form a wiring pattern in the printed circuit board to make connection with another IC. Therefore, it is less likely that short-circuit defects with other signals due to disconnection or foreign materials will occur.

With regard to the drive circuit 17c, the two N-channel MOSFETs 22a, 22b as the driving transistors are connected in series between the power source and the ground, and the short-circuit restricting circuit 24 is configured to set either the N-channel MOSFET 22a or the N-channel MOSFET 22b in the on state. Therefore, the short-circuit as the two MOSFETs 22a, 22b being simultaneously in the on state can be restricted. Moreover, since the drive circuit 17c is provided within the control IC 2, the driving of the motor 6 can be stopped immediately after the detection of a computation malfunction of the microcomputer 3 and/or the decrease in the power source.

The drive circuit 17c for driving the motor 6 is integrally formed in the control IC 2. Therefore, in the driving of the motor 6, which needs to be controlled at a microsecond rate, the driving of the motor 6 can be immediately stopped when the abnormal state of the microcomputer 3 is detected.

### OTHER EMBODIMENTS

The determination of the state of the microcomputer 3 after the resetting may be made based on whether a predetermined signal is received in a program that operates in the normal state or by checking a protocol of communication performed by the microcomputer 3 after the resetting or a check pattern of signals received after the resetting of the microcomputer 3, other than the counting of the number of the watchdog signals.

In the monitoring by the watchdog monitor circuit 12, the number of the watchdog signals to be received after the reset of the microcomputer 3 for the determination of the normal state is exemplarily set to ten. However, the number of the watchdog signals for the determination is not limited to ten, but may be any other plural number as long as the state of the microcomputer 3 can be properly confirmed.

The logic fixed resistor is provided by the pull-up resistor 21, for example. Alternatively, a pull-down resistor may be employed when the logic is different or opposite. The drive circuit 17b and the prohibition circuit 16b for the relay 5b may have similar configurations to those of the drive circuit 17a and the prohibition circuit 16a for the relay 5a. The in-vehicle loads are not limited to the relays 5a, 5b and the motor 6, but may be any other devices.

In the drive circuit 17c for the motor 6, the inverter circuit 22 may employ bipolar transistors or IGBTs, in place of the N-channel MOSFETs 22a, 22b.

Based on the above, an electronic control unit for a vehicle includes a microcomputer 3 and a semiconductor integrated circuit device (e.g., control IC) 2. The microcomputer 3 performs a processing for controlling an in-vehicle load, such as a relay 5a, 5b or a motor 6. The semiconductor integrated circuit device 2 integrally has a drive circuit 17a, 17b, 17c, a prohibition circuit 16a, 16b, 16c and a pulse monitor circuit (e.g., watchdog monitor circuit) 12. The drive circuit 17a, 17b, 17c drives the in-vehicle load according to a driving signal outputted from the microcomputer 3. The pulse monitor circuit 12 monitors a pulse signal that is outputted from the microcomputer 3 when the microcomputer 3 is in a normal state. The pulse monitor circuit 12 resets the microcomputer 3 and instructs the prohibition circuit 16a, 16b, 16c to prohibit the drive circuit from driving the in-vehicle load 5a, 5b, 6 when it is determined that the microcomputer 3 is in an abnormal state. The pulse monitor circuit 12 instructs the prohibition circuit 16a, 16b, 16c to permit the drive circuit 17a, 17b, 17c to drive the in-vehicle load 5a, 5b, 6 when it is determined that the microcomputer 3 is in the normal state after resetting of the microcomputer 3. In such a configuration, the driving of the in-vehicle load 5a, 5b, 6 is permitted when it is determined that the microcomputer 3 works properly after the resetting. Therefore, it is less likely that the in-vehicle load 5, 5b, 6 will be undesirably operated even if the microcomputer 3 is in an abnormal state after the resetting.

The above control is performed by the semiconductor integrated circuit device 2 in which the pulse monitor circuit 12, the prohibition circuit 16a, 16b, 16c and the drive circuits 17a, 17b, 17c are integrally provided. Therefore, signal transmission with another semiconductor integrated circuit device is not necessary. With this, abnormal signal transmission due to disconnection of a wiring pattern of a printed circuit board with the other semiconductor integrated circuit device or short-circuits with other signals due to foreign materials is reduced. Also, abnormal signal transmission due to external noises is reduced. Further, since the signal transmission with another semiconductor integrated circuit device is not performed, delay of the signal transmission is reduced. Therefore, the driving of the in-vehicle load 5a, 5b, 6 can be stopped immediately after the detection of an abnormal state of the microcomputer 3 (e.g., several tens of nanoseconds). As such, the reliability of driving operation of the microcomputer 3 improves. In addition, since the prohibition circuit 16a, 16b, 16c and the drive circuit 17a, 17b, 17c are connected within the semiconductor integrated circuit device 2, the number of pins of the semiconductor integrated circuit device 2 is reduced, resulting in a reduction of cost.

For example, the pulse monitor circuit 12 determines that the microcomputer 3 is in the normal state when a predetermined number of pulse signals has been outputted from the microcomputer 3 after the resetting. Therefore, the state of the microcomputer 3 is properly determined based on the normal pulse signals that are repeatedly inputted without being affected by noises or the like.

While only the selected exemplary embodiments have been chosen to illustrate the present disclosure, it will be apparent to those skilled in the art from this disclosure that various changes and modifications can be made therein without departing from the scope of the disclosure as defined in the appended claims. Furthermore, the foregoing description of the exemplary embodiments according to the present disclosure is provided for illustration only, and not for the purpose of limiting the disclosure as defined by the appended claims and their equivalents.

What is claimed is:

1. An electronic control unit for a vehicle, comprising:
a microcomputer performing a processing for controlling an in-vehicle load; and
a semiconductor integrated circuit device integrally having:
a drive circuit driving the in-vehicle load according to a driving signal outputted from the microcomputer;
a prohibition circuit; and
a pulse monitor circuit monitoring a pulse signal outputted from the microcomputer when the microcomputer is in a normal state, the pulse monitor circuit resetting the microcomputer and instructing the prohibition circuit to prohibit the drive circuit from driving the in-vehicle load when it is determined that the microcomputer is in an abnormal state, and the pulse monitor circuit instructing the prohibition circuit to permit the drive circuit to drive the in-vehicle load when it is determined that the microcomputer is in the normal state after resetting of the microcomputer.

2. The electronic control unit according to claim 1, wherein
the pulse monitor circuit determines that the microcomputer is in the normal state when a predetermined number of pulse signals has been outputted from the microcomputer after the resetting.

3. The electronic control unit according to claim 1, wherein
the semiconductor integrated circuit device further has a power supply monitor circuit,
the power supply monitor circuit monitors a power-supply voltage supplied to the microcomputer,
the power supply monitor circuit retains the microcomputer in a reset state and instructs the prohibition circuit to prohibit the drive circuit from driving the in-vehicle load when the power-supply voltage is detected equal to or lower than a predetermined level, and
the power supply monitor circuit releases the microcomputer from the reset state when the power-supply voltage exceeds the predetermined level, and instructs the prohibition circuit to permit the drive circuit to drive the in-vehicle load when it is determined that the microcomputer is in the normal state after the resetting.

4. The electronic control unit according to claim 3, wherein
the semiconductor integrated circuit device further has a boosting circuit that generates a voltage to be supplied to the power supply monitor circuit.

5. The electronic control unit according to claim 3, wherein
the semiconductor integrated circuit device further has a voltage detection circuit that detects a driving voltage for driving the in-vehicle load from the drive circuit, and instructs the prohibition circuit to prohibit electric power supply to the in-vehicle load when the driving voltage is detected equal to or lower than a predetermined level.

6. The electronic control unit according to claim 5, wherein
the semiconductor integrated circuit device further has a boosting circuit that generates a voltage to be supplied to the voltage detection circuit.

7. The electronic control unit according to claim 6, wherein
the drive circuit has an N-channel MOSFET for driving the in-vehicle load, and
the N-channel MOSFET is driven as the voltage generated by the boosting circuit is applied to a gate of the N-channel MOSFET.

8. The electronic control unit according to claim 1, wherein
the drive circuit has a fixed logic resistor at an input side thereof, and
the fixed logic resistor is configured to provide a logic where the driving signal outputted from the microcomputer sets the in-vehicle load to a stopped state during the resetting of the microcomputer.

9. The electronic control unit according to claim 3, wherein
the semiconductor integrated circuit device further has a microcomputer power-supply circuit that generates the power-supply voltage.

10. The electronic control unit according to claim 3, wherein
the drive circuit has two driving transistors connected in series between a power source and a ground, and
an electric power supply to the in-vehicle load is controlled by switching on and off states of the two driving transistors according to the driving signal outputted from the microcomputer so that only one of the driving transistor is in an on state.

11. The electronic control unit according to claim 10, wherein the drive circuit drives a motor as the in-vehicle load.

12. A semiconductor integrated circuit device comprising:
a drive circuit driving an in-vehicle load according to a driving signal outputted from a microcomputer that is provided to perform a processing for controlling the in-vehicle load;
a prohibition circuit; and
a pulse monitor circuit monitoring a pulse signal outputted from the microcomputer when the microcomputer is in a normal state, the pulse monitor circuit outputting a reset signal to the microcomputer to reset the microcomputer and instructing the prohibition circuit to prohibit the drive circuit from driving the in-vehicle load when it is determined that the microcomputer is in an abnormal state, and the pulse monitor circuit instructing the prohibition circuit to permit the drive circuit to drive the in-vehicle load when it is determined that the microcomputer is in the normal state after resetting of the microcomputer.
